(19) United States
(12) Patent Application Publication
(10) Pub. No.: US 2010/0083794 A1
(43) Pub. Date: Apr. 8, 2010

(54) Double-ended tool for opening soft-sided sealed condiment packets and fluid containers having membrane seals

(76) Inventor: Albert Morgan Galpin, Peachland (CA)

Correspondence Address: Antony C. Edwards, P.O. Box 26020, Westbank, BC, V4T 2G3, CA

(21) Appl. No.: 12/285,533

(22) Filed: Oct. 8, 2008

(51) Int. Cl. B67B 7/00

(52) U.S. Cl. 81/3.48; 81/3.4

(57) ABSTRACT

A condiment opening tool includes a central connecting body having first and second opposite ends, at least one prong having a pointed end, and mounted to the first end of the connecting body so as to extend the pointed end away from said connecting body. A pair of arms are mounted to the second end of the connecting body to as to extend away from the connecting body in substantially oppositely disposed relation to the prong or prongs. The pair of arms include first and second arms. The prong may be a pair of prongs. A pointed piercing member is mounted on, and perpendicularly to, a distal end of said first arm so as to be directed towards a distal end of said second arm. The point of the piercing member is adjacent the distal end of the second arm has so as to define a gap therebetween sized for sliding a condiment packet into the gap. The arms are deflected to pierce the packet with the point.

### FIELD OF THE INVENTION

The present invention relates to the field of devices for opening condiment packets and membrane-closed fluid containers, and in particular to a double-ended tool having on one end a pair of piercing arms for opening condiment packets, and on its opposite end a pair of prongs for piercing the membrane of a membrane-closed fluid container.

### BACKGROUND OF THE INVENTION

As noted by Navot et al in U.S. Pat. No. 6,263,772, sealed bag-like, flexible packets containing pourable substances are widely used. Such packets may contain comestible substances, such as ketchup, mustard, mayonnaise, various types of sauces, or other type of substances, e.g., adhesives, sealing materials and the like. In order to preserve the substances contained in the packets for a long period of time, the packets are usually made of air-tight multi-ply materials such as foil and plastic. While the packets are indeed effective in preserving their contents in good condition for an extended period of time, and are mechanically strong, withstanding abuses, the user has a difficult time in opening the packets unless a special tool such as scissors or knives are provided. Conventionally a notch or cut is provided at the lateral edge of such a rectangular packet to assist in the task of opening the packet by a user tearing along the notch or cut. However, such an operation more often than not, may result in spilling, or worse, spraying the surroundings with the contents of the packet.

The opening of such packets using the aforesaid notch or cut is considerably difficult if the user is weakened due to infirmity or other health or age related causes, or has difficulty with manual dexterity when manipulating small objects due to arthritis, over-sized digits, weak eyesight, or other health, size, or age related causes. Further, the same or like restrictions or ailments of the user also make it difficult for the user to open membrane covered or membrane sealed, collectively herein referred to as membrane sealed, fluid containers such as the conventional cream dispensers which comprise small cups having a foil covering. To open the covering the user must grasp a small foil tab on one side of the foil and pull the foil back against the sealing force of the adhesive binding the foil to the rim of the cup.

In the prior art already noted above, Navot et al, in their U.S. Pat. No. 6,263,772, disclose two embodiments; namely, one having a blade and the other having a point, where both the blade and the point are mounted on the free end of one limb of a pair of limbs. In the blade embodiment, the pair of limbs define an open-ended slot and the blade is mounted in the open-end of the slot. The end of a packet is slid into the slot, the limbs squeezed and the device is pulled away from packet to slice the end off the packet. In the point embodiment the pair of limbs are hinged together at one corresponding end of each limb at 90 degrees. In operation the end of a packet is placed between the two free ends of the limbs when the hinge is open, and the free-ends of the limbs are then brought together to pierce a hole in the packet. As the device is pinching it creates a cut in the packet. Once the packet has been sliced or pierced respectively, the non-opened end of the packet may be placed into an elongate slot between the limbs sized to receive the entire width of the packet and the limbs squeezed together and slid down the packet towards the open end or the limbs used to roll the closed end of the packet, both techniques to force the contents from the packet through sliced or pierced end.

In the prior art applicant is also aware of U.S. Pat. No. 5,101,562 which issued to Horvath et al wherein Horvath et al disclose a cutting squeezer tool for a condiment foil pouch, the tool consists of an elongated flat handle so that a person using the tool can grip the handle and a mechanism on the end of the handle for cutting the edge of the condiment foil pouch and for squeezing the contents out of the condiment foil pouch.

### SUMMARY OF THE INVENTION

In summary, the condiment opening tool according to the present invention includes a central connecting body having first and second opposite ends, a prong having a pointed end, and mounted to the first end of the connecting body so as to extend the pointed end away from the connecting body, and a pair of arms mounted to the second end of the connecting body to as to extend away from the connecting body in substantially oppositely disposed relation to the prong, wherein the pair of arms include first and second arms. The prong may in a preferred embodiment be a pair of prongs. The pair of prongs may be substantially parallel and terminate equidistant from the connecting body. A pointed piercing member is mounted perpendicularly to a distal end of the first arm so as to be directed towards a distal end of the second arm.

The piercing member has a point at a distal end thereof. The point is adjacent the distal end of the second arm has so as to define a gap therebetween sized for sliding a condiment packet into the gap. At least one of the first and second arms are movable relative to the connecting body so as to bring the distal ends of the first and second arms together whereby a condiment packet in the gap between the piercing member and the distal end of the second arm is pierced and is torn open by pulling the tool relative to the packet. The piercing member may be a lancet.

In one embodiment at least one of the first and second arms is flexible so as to move relative to the connecting body. For example, the first arm may be flexible.

The first and second arms may be substantially linear and parallel, and the piercing member may be substantially orthogonal to the first arm.

### BRIEF DESCRIPTION OF THE DRAWINGS

In the figures wherein like characters of reference denote corresponding parts in each view:

FIG. 1 is, in perspective view, the condiment opener according to one preferred embodiment of the present invention wherein twin puncturing spikes are provided; and,

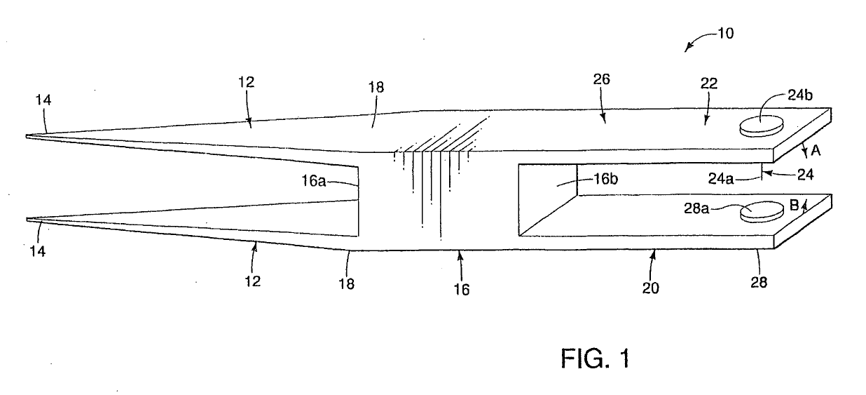

FIG. 1a is an alternative embodiment of the condiment opener of the present invention wherein only a single puncturing spike is provided.

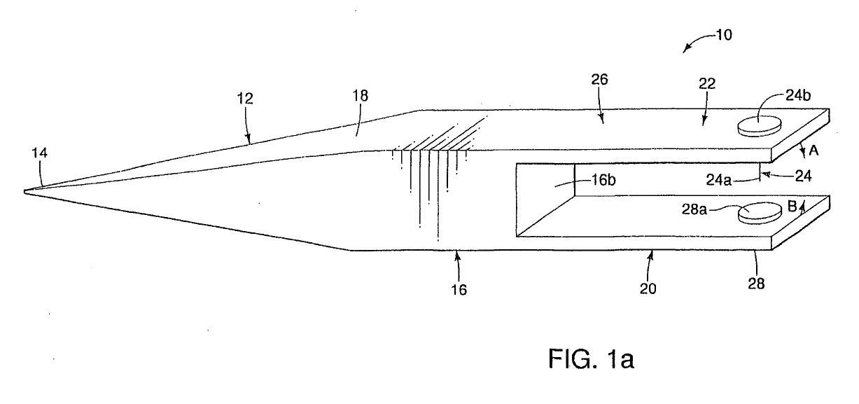

FIG. 2 is, in side elevation view, the condiment opener of FIG. 1, shown puncturing the lid on a cream container.

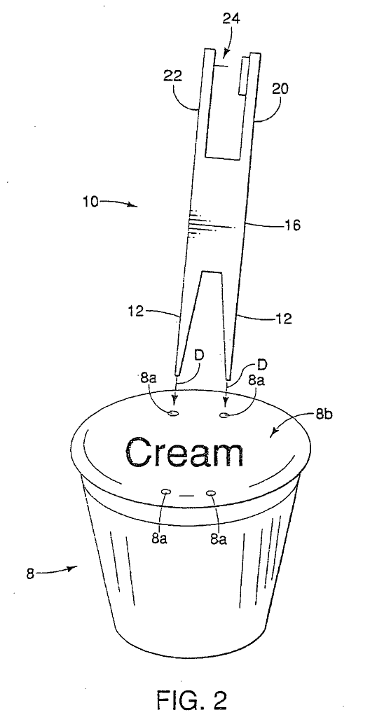

FIG. 3 is the condiment opener of FIG. 2 opening a ketchup packet.

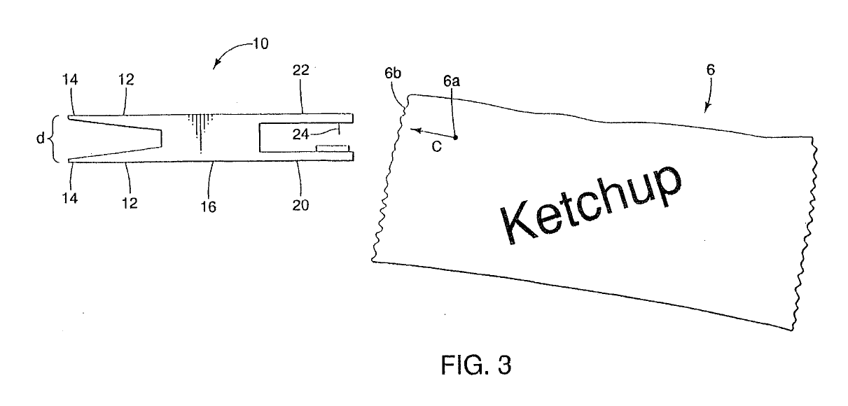

### DETAILED DESCRIPTION OF EMBODIMENTS OF THE INVENTION

The condiment opening apparatus 10 comprises a body having a pair of substantially parallel spaced apart spike arms 12, each arm having a sharpened tip 14 at a distal end thereof. In a second embodiment only a single spike arm 12 is provided. A central connecting body 16 joins, at end 16a the two arms 12 to each other at a proximate end 18 of each arm. An oppositely disposed pair of clamping arms 20 and 22, opposite to the pair of arms 12, extend from the central body 16.

Clamping arm 22 has a lancet 24 mounted thereon. Lancet 24 has a sharpened point 24a oriented in a direction towards the clamping arm 20. Advantageously lancet 24 is substantially or generally orthogonal to arm 22 at the free end or distal end thereof. Clamping arm 22 is flexible or at least includes a flexible or pivoting portion such as at 26 adjacent to the mounting of clamping arm 22 to the main connecting body 16.

The lancet 24 is located on clamping arm 22 in a location such that when clamping arm 22 is deflected or rotated in direction A, for example about the flexible portion 26, the point 24a may be positioned adjacent to the distal end 28 of clamping arm 20. Clamping arm 20 may also be flexible or include a flexible or pivoting portion so that distal end 28 may be urged towards point 24a in direction B as arm 22 is deflected. Preferably point 24a may be brought into contact with distal end 28 by the bending of one or both of arms 20 and 22.

When grasped by a user, clamping arm 22 may be flexed, deflected or rotated such that the point 24a comes adjacent or contacts the distal end 28 so that a packet 6 or the like held between arms 20 and 22 may be punctured at puncture 6a whereupon retraction in direction C of the lancet 24 through, for example longitudinally along the end of the condiment packet will create a sliced or torn opening from the puncture 6a to edge 6b of the packet.

The sharpened points 14 of the arms 12 may be utilized to puncture holes or apertures 8a in condiment containers enclosing a liquid by a membrane seal 8b, such as example the peel-back sealed lid on creamer container 8. Points 14 are driven in direction D through the lid so as to create spouts for decanting the fluid from the container. The distanced between the points 14 may be selected such that the distance therebetween provides twin spouts relatively close together on one side i.e. the lower side when pouring, and punctures on the opposite upper side when pouring allow in enough air flow to enable smooth pouring of the fluid through the lower twin spouts.

In a further embodiment the distance from the point 24a to the end 16b of the connecting body 16 may be selected such that the edge of a pudding or yogurt container (not shown) may be placed therebetween. Accordingly, the user may position the tool such that the point 24a is located in the top portion of a pudding or yogurt container and such that rotation of the tool around the annular rim of the container will open an annular opening around the inside edge of the annular ring of the container.

In one embodiment, and as illustrated, the condiment opening tool has a length of approximately four centimeters, and fits with in the hand of a user (not shown).

In one preferred embodiment, lancet 24 is the size of the lancet spike of a Finepoint™ lancet sold by Lifescan™ Canada Ltd of Burnaby, British Columbia, Canada. A reinforcing base 24b may be provided to assist in mounting and stabilizing lancet 24 into the end of arm 22. An elevated point engaging pad 28a may be mounted on the inner surface of distal end 28 of arm 20 for engaging point 24a to help stabilize the point as it is pulled through a condiment packet.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A condiment opening tool comprising:
a central connecting body having first and second opposite ends,
a prong having a pointed end, said prong mounted to said first end of said connecting body so as to extend said pointed end away from said connecting body,
a pair of arms mounted to said second end of said connecting body as to extend away from said connecting body in substantially oppositely disposed relation to said prong, said pair of arms including first and second arms,
a pointed piercing member mounted to a distal end of said first arm and directed towards a distal end of said second arm,
at least one of said first and second arms rotatable relative to said connecting body so as to bring said point and said distal end of said second arm together whereby a packet in said gap is pierced or torn open by pulling the tool relative to the packet,
said piercing member having a point at a distal end thereof, said point adjacent said distal end of said second arm so as to define a gap therebetween sized for sliding a condiment packet into said gap,

2. The tool of claim 1 wherein at least one of said first and second arms is flexible so as to said rotate relative to said connecting body.

3. The tool of claim 2 wherein said first arm is flexible.

4. The tool of claim 1 wherein said piercing member is chosen from a group which includes: a lancet, a blade, a spike, a pin, a needle.

5. The tool of claim 1 wherein said first and second arms are substantially linear and said piercing member is substantially orthogonal to said first arm.

6. The tool of claim 1 wherein said first and second arms are substantially parallel and said piercing member is substantially orthogonal to said first arm.

7. The tool of claim 1 wherein said prong includes a pair of said prongs.

8. The tool of claim 7 wherein each arm of said first and second arms are substantially parallel with each other and wherein said each arm is substantially co-linear with a corresponding prong of said pair of said prongs.

9. The tool of claim 8 wherein said piercing member is substantially orthogonal to said first arm.

10. The tool of claim 9 wherein said piercing member is chosen from a group which includes: a lancet, a blade, a spike, a pin, a needle.

11. The tool of claim 9 wherein at least said first arm is flexible so as to said rotate relative to said connecting body.
